(19) United States
(12) Patent Application Publication
(10) Pub. No.: US 2024/0336249 A1
(43) Pub. Date: Oct. 10, 2024

(54) DRIVING AND STEERING CONTROL SYSTEM, BUILT-IN DRIVING AND STEERING UNIT SYSTEM, BUILT-IN DRIVING AND STEERING UNIT, AND AUTONOMOUS GROUND VEHICLE

(71) Applicant: YAMAHA HATSUDOKI KABUSHIKI KAISHA, Iwata-shi (JP)

(72) Inventor: Ryohei HIROSE, Shizuoka (JP)

(21) Appl. No.: 18/749,549

(22) Filed: Jun. 20, 2024

Related U.S. Application Data
(63) Continuation-in-part of application No. PCT/JP2021/047269, filed on Dec. 21, 2021.

(51) Int. Cl. B60W 10/20; B60W 10/08; B60W 30/045; B60W 60/00

(52) U.S. Cl. CPC B60W 10/20; B60W 10/08; B60W 30/045; B60W 60/001; B60W 2520/28; B60W 2540/18; B60W 2710/083; B60W 2710/202

(57) ABSTRACT

A driving and steering control system to be employed in an autonomous ground vehicle. The driving and steering control system includes: an acquisition device that is configured to acquire, from an upper-level control section, propulsion motor actuation instruction information for actuating a propulsion motor of the vehicle and the steering motor actuation instruction information for actuating a steering motor of the vehicle; and a motor information processing device that is configured to concurrently actuate the propulsion motor and the steering motor in such a manner to concurrently change an operation parameter of the steering motor and an operation parameter of the propulsion motor based on the steering motor actuation instruction information acquired by the acquisition device, and concurrently change the operation parameter of the propulsion motor and the operation parameter of the steering motor based on the propulsion motor actuation instruction information acquired by the acquisition device.

### CROSS REFERENCE TO RELATED APPLICATIONS

This application is a Continuation-in-Part Application of International Application No. PCT/JP2021/047269, filed on Dec. 21, 2021, the entire contents of which are incorporated herein by reference.

### TECHNICAL FIELD

The present teaching relates to a driving and steering control system, a built-in driving and steering unit system, a built-in driving and steering unit, and an autonomous ground vehicle.

### BACKGROUND ART

As vehicles capable of running without human operation, autonomous ground vehicles are known. Such an autonomous ground vehicle, for example, includes a plurality of wheels, and propulsion motors and steering motors that are provided individually for the plurality of wheels. The propulsion motors, for example, transmit power to the wheels so that the autonomous ground vehicle can move forward and backward. The steering motors, for example, transmit power to the wheels so that the autonomous ground vehicle can turn left and right. Such autonomous ground vehicles are disclosed in Patent Literature 1 and Patent Literature 2, for example.

Patent Literature 1 discloses a self-propelled mower that includes three wheels, propulsion motors and steering motors provided individually for the three wheels. The three wheels of this self-propelled mower are steered by the steering motors and rotated around axles by the propulsion motors independently of one another. The propulsion motors and the steering motors are attached to the vehicle body of the self-propelled mower. The propulsion motors and the steering motors are connected to the wheels via steering shafts. Each of the steering shafts is positioned in such a manner to have a scrub radius relative to the corresponding wheel.

Patent Literature 2 discloses an omnidirectional mobile vehicle that includes a caster-like wheel, a propulsion motor that rotates the wheel, and a steering motor that steers the wheel. In this omnidirectional mobile vehicle also, the steering shaft is positioned in such a manner to have a scrub radius in relation to the wheel.

### CITATION LIST

### Patent Literature

Patent Literature 1: US Patent Application Publication No. 2007/0260370
Patent Literature 2: Japanese Patent Application Publication No. 2001-199356

### SUMMARY OF INVENTION

### Technical Problem

An objective of the present teaching is to reduce both speed interference and torque interference between a steering motor and a propulsion motor in an autonomous ground vehicle of which the wheels have a scrub radius.

Let us consider a case of steering one of the wheels of a vehicle with their scrub radius while the vehicle is at a stop. At that time, to keep the vehicle at a stop, a propulsion motor is instructed to keep its rotation speed at zero and a steering motor is instructed to rotate by a specified amount. Accordingly, the propulsion motor does not rotate, and only the steering motor rotates. Because of the scrub radius, the wheel is not steered on the site and is steered in such a manner to make a trace like a circular arc with a radius equal to the scrub radius around the steering axis. In this case, the wheel needs to rotate around the axle by an amount corresponding to the length of the trace.

However, since the propulsion motor is instructed to stop, the propulsion motor causes resistance on the steered motion of the wheel. In other words, the propulsion motor works to interfere with the steering of the wheel and causes speed interference with the steering motor. Consequently, in order to steer the wheel smoothly, the steering motor needs to output a greater torque than originally needed, which may lead to a reduction in energy efficiency. Additionally, this may require a steering motor with a greater output torque, and in this case, the amount of heat generation of the steering motor becomes greater, which may require countermeasures against heat. This may lead to an increase in the size of the steering motor. Furthermore, if the wheel is steered without rotating around the axle, the wheel may scrape against the ground. For example, on farms, golf courses and the like, less friction between the wheel and the ground is preferable.

In the case of the self-propelled mower disclosed in Patent Document 1, when a wheel is steered, the rotation speed of the wheel is adjusted based on the scrub radius. In the case of the omnidirectional mobile vehicle disclosed in Patent Literature 2, a scrub radius is set taking into account the speed interference between the propulsion motor and the steering motor at a time of steering the wheel while the vehicle is at a stop. In these ways, the vehicles disclosed in Patent Literature 1 and Patent Literature 2 reduce speed interference between the propulsion motor and the steering motor.

The present inventor studied an autonomous ground vehicle with the wheels having a scrub radius. As a result, the present inventor found that in an autonomous ground vehicle in which a plurality of wheels are steered and driven independently of one another, there are cases in which between a propulsion motor and a steering motor, some mutual interference other than speed interference as described above is also caused.

For example, let us consider a case of accelerating an autonomous ground vehicle straight forward without the wheels being steered. In this case, the vehicle's instruction of each of the propulsion motors is to output a specified number of rotations or a specified torque and the vehicle's instruction of each of the steering motors is to keep the steering angle of the corresponding wheel at zero. Therefore, the steering motors do not rotate the wheels, and only the propulsion motors rotate the wheels. When the vehicle is accelerating forward, each of the steering shafts receives a moment corresponding to a value of multiplying the scrub radius with the wheel driving force. This moment acts as a disturbance moment for the steering control system, causing the steering angle to deviate from a target value.

At that time, the steering motors are instructed to stop. Nevertheless, the steering shafts receive the above-mentioned disturbance moment and are about to steer the wheels, which causes torque interference between the steering motors and the propulsion motors. For example, in the case of an autonomous vehicle having a left-right pair of independently controllable wheels, when the steering angles of the wheels deviate from target values due to torque interference, the toe angles deviate from target values, and the rolling resistance of the wheels also changes. When the rolling resistance increases, the loads on the propulsion motors increase, resulting in a reduction in energy efficiency.

The resistances that a vehicle undergoes include gradient resistance, air resistance, acceleration resistance, etc., as well as rolling resistance. An autonomous ground vehicle usually runs at a slow speed on level ground. In the case of an autonomous ground vehicle, the proportion of the rolling resistance to all kinds of resistances that the autonomous ground vehicle undergoes is large, as compared with other types of vehicles. Therefore, it is preferable that the steering angle deviation from a target value caused by torque interference be small.

In this regard, it is possible to reduce the steering angle deviation from a target value by feedback control. For example, let us assume that while a vehicle is accelerating straight forward, the steering angle of a wheel deviates from a target value. The vehicle includes a steering angle sensor. The steering angle sensor detects the amount of steering angle deviation of the wheel. The steering angle sensor sends the detected amount of steering angle deviation to a control device of the steering motor. The control device actuates the inactive steering motor based on the received amount of steering angle deviation to steer the wheel.

By such feedback control, even if the steering angle of the wheel deviates from a target value, it is possible to return the steering angle of the wheel to the target value by actuating the steering motor. However, the feedback control is ex post facto handling, and therefore, during a transient period after the steering shaft receives a disturbance moment until the steering angle of a targeted wheel is restored to a target value, the steering angle of the wheel stays different from the target value.

The present inventor conducted a further study on speed interference and torque interference between a propulsion motor and a steering motor. As a result, the inventor found that there are some cases in which speed interference and torque interference between a propulsion motor and a steering motor occur. These cases are aside from an instance whereby a wheel is being steered while the vehicle is at a stop and an instance whereby the vehicle is accelerated straight forward without the wheels being steered.

For example, let us consider a case in which a vehicle turns, that is, a case of steering the wheels while accelerating the vehicle forward. In this case, the vehicle actuates the propulsion motors and concurrently actuates the steering motors. Since the propulsion motors operate, torque interference as described above occurs. Since the steering motors operate, speed interference as described above occurs. Thus, it was found that both speed interference and torque interference between the propulsion motors and the steering motors occur when a vehicle turns.

The present inventor conducted a study about techniques to reduce speed interference and torque interference in all the cases in which either speed interference or torque interference between a propulsion motor and a steering motor occurs alone and in which speed interference and torque interference between a propulsion motor and a steering motor both occur. As a result, the inventor arrived at the structures that are as described below.

(1) A driving and steering control system according to an embodiment of the present teaching is to be employed in an autonomous ground vehicle that is capable of running without a driver in/on the vehicle and includes a plurality of wheels. The autonomous ground vehicle comprises: a targeted wheel that is one of the plurality of wheels; a propulsion motor that rotates the targeted wheel around an axle of the targeted wheel; a steering motor that steers the targeted wheel to the left and right; and a steering shaft that is connected to the steering motor, is configured such that the targeted wheel is steered to the left and right by operation of the steering motor, and is positioned in such a manner to have a scrub radius relative to the targeted wheel. The driving and steering control system comprises: an acquisition part that is capable of acquiring propulsion motor actuation instruction information that instructs to actuate the propulsion motor and steering motor actuation instruction information that instructs to actuate the steering motor from an upper-level control section that is superior to the driving and steering control system; and a motor information processing part that actuates the propulsion motor and concurrently actuates the steering motor in such a manner to: change an operation parameter of the steering motor and concurrently change an operation parameter of the propulsion motor based on the steering motor actuation instruction information acquired by the acquisition part; and change the operation parameter of the propulsion motor and concurrently change the operation parameter of the steering motor based on the propulsion motor actuation instruction information acquired by the acquisition part.

When the driving and steering control system of (1) acquires the steering motor actuation instruction information that instructs to actuate the steering motor, the driving and steering control system of (1) actuates not only the steering motor but also the propulsion motor. When the targeted wheel is steered, the targeted wheel can be rotated around the axle. This makes it possible to reduce speed interference, which is interference from the propulsion motor in steering of the targeted wheel as described above. Additionally, when this driving and steering control system acquires the propulsion motor actuation instruction information that instructs to actuate the propulsion motor, the driving and steering control system actuates not only the propulsion motor but also the steering motor. When the targeted wheel is rotated around the axle, that is, when the targeted wheel receives a moment around the steering shaft by driving torque, the targeted wheel can be steered. This makes it possible to reduce torque interference that causes the steering angle of the targeted wheel to deviate from a target value as described above. Thus, with the above-described driving and steering control system, an autonomous ground vehicle with the wheels having a scrub radius can reduce both speed interference and torque interference between a steering motor and a propulsion motor.

(2) In the above-described driving and steering control system, while the motor information processing part is actuating both the steering motor and the propulsion motor based on the steering motor actuation instruction information and the propulsion motor actuation instruction information, when the acquisition part receives a new piece of steering motor actuation instruction information or propulsion motor actuation instruction information that provides a change in either one of the steering motor actuation instruction information and the propulsion motor actuation instruction information without changing the other actuation instruction information, the motor information processing part may actuate the propulsion motor and concurrently actuate the steering motor so as to change both the operation parameters of the steering motor and the propulsion motor.

In the driving and steering control system of (2), when the steering motor actuation instruction information or the propulsion motor actuation instruction information is changed, both the operating conditions of the propulsion motor and the steering motor are changed. For example, let us assume that the autonomous ground vehicle is jacked up off the ground, whereby the targeted wheel is put in the air. In this state, when the acquisition part acquires steering motor actuation instruction information and propulsion motor actuation information that instruct to stop the autonomous ground vehicle and to steer the targeted wheel, the targeted wheel is steered by the steering motor and can be rotated by operation of the propulsion motor in order to reduce speed interference. In this state, when the acquisition part acquires propulsion motor actuation instruction information that instructs to move the autonomous ground vehicle forward, the number of rotations of the targeted wheel increases, and concurrently the steering angle of the targeted wheel changes. The reason is as follows. Torque interference could occur only because the wheel is on the ground, and when the wheel is not on the ground (i.e., when the wheel is in the air), torque interference could never occur. Accordingly, when the wheel is in the air, the control by the driving and steering control system to reduce torque interference appears as a phenomenon of a steering angle change of the targeted wheel. In sum, when the steering motor actuation instruction information or the propulsion motor actuation instruction information is changed while the targeted wheel is in the air, the effects on both the number of rotations and the steering angle of the targeted wheel are observable.

(3) In the driving and steering control system of (1) or (2) above, when the acquisition part receives the steering motor actuation instruction information and the propulsion motor actuation instruction information, the motor information processing part may actuate the propulsion motor and concurrently actuate the steering motor such that the propulsion motor is inhibited from interfering with the steering motor in steering of the targeted wheel, and also such that a change in the steering angle caused by the propulsion motor is inhibited by the steering motor.

With the driving and steering control system of (3), the propulsion motor and the steering motor are actuated in such a manner to reduce both speed interference and torque interference between the propulsion motor and the steering motor. This allows an autonomous ground vehicle with the wheels having a scrub radius to reduce both speed interference and torque interference between a steering motor and a propulsion motor.

(4) The driving and steering control system of (1) to (3) above may further comprise a built-in driving and steering unit that is attachable to the autonomous ground vehicle. The built-in driving and steering unit includes the targeted wheel, the propulsion motor, the steering motor, and the steering shaft.

With the driving and steering control system of (4), the built-in driving and steering unit is attachable to and detachable from the vehicle body of an autonomous ground vehicle. It is possible to use the built-in driving and steering unit in various autonomous ground vehicles, and the built-in driving and steering unit is easily replaceable. This allows an autonomous ground vehicle with the wheels having a scrub radius to reduce both speed interference and torque interference between a steering motor and a propulsion motor, and this improves the versatility of the driving and steering control system.

(5) In the driving and steering control system of (1) to (4) above, the steering motor actuation instruction information and the propulsion motor actuation instruction information may be configured without inclusion of information on the scrub radius and free of any basis on the scrub radius.

In order to efficiently reduce both speed interference and torque interference between a steering motor and a propulsion motor, information on the scrub radius is necessary. This means that the steering motor actuation instruction information and the propulsion motor actuation instruction information inputted to the driving and steering control system need to include information on the scrub radius. In this case, however, the upper-level control section that sends the input information needs to have information on the scrub radius, and it is necessary to make settings of the upper-level control section beforehand. Specifically, the built-in driving and steering unit is attachable to various vehicles, and when the vehicles to which such built-in driving and steering units are to be attached include upper-level control sections, it is necessary to make settings of each of the upper-level control sections in the vehicles to which such built-in driving and steering units are to be attached so that each of the upper-level control sections can compose steering motor actuation instruction information and propulsion motor actuation instruction information taking into account the scrub radius of the vehicle, which increases the number of processes. In the driving and steering control system of (5), the steering motor actuation instruction information and the propulsion motor actuation instruction information that are inputted from the upper-level control section are configured without inclusion of information on the scrub radius. However, the driving and steering control system is capable of actuating the propulsion motor and the steering motor in such a manner to reduce both speed interference and torque interference. Thus, even though the information inputted thereto does not include information on the scrub radius, it is possible to reduce both speed interference and torque interference. This is beneficial especially to built-in driving and steering units. For example, only if the driving and steering control system grasps the scrub radius of the built-in driving and steering unit beforehand, the vehicle to which the built-in driving and steering unit is attached can reduce both speed interference and torque interference efficiently without having acquired information on the scrub radius. This allows an autonomous ground vehicle with the wheels having a scrub radius to reduce both speed interference and torque interference between a steering motor and a propulsion motor, and this further improves the versatility of the driving and steering control system.

(6) In the driving and steering control system of (1) to (5) above, both the propulsion motor and the steering motor may be in-wheel motors mounted to the targeted wheel.

When the propulsion motor and the steering motor are in-wheel motors, it is difficult to locate the targeted wheel and the steering shaft close to each other because of the vehicle structure. In other words, the scrub radius is likely to be large. Especially in the case of the built-in driving and steering unit, when the propulsion motor and the steering motor are in-wheel motors, the scrub radius is likely to be large. However, the driving and steering control system of (6) actuates the propulsion motor and the steering motor in such a manner to reduce both speed interference and torque interference. Therefore, even though the propulsion motor and the steering motor are in-wheel motors, that is, even though the vehicle has a large scrub radius, it is possible to reduce both speed interference and torque interference.

(7) A built-in driving and steering unit system according to an embodiment of the present teaching is to be employed in an autonomous ground vehicle that is capable of running without a driver in/on the vehicle and includes a plurality of wheels. The built-in driving and steering unit system comprises: a built-in driving and steering unit that is attachable to the autonomous ground vehicle; and a control device. The built-in driving and steering unit comprises: a targeted wheel that is one of the plurality of wheels; a propulsion motor that rotates the targeted wheel around an axle of the targeted wheel; a steering motor that steers the targeted wheel to the left and right; and a steering shaft that is connected to the steering motor, is configured such that the targeted wheel is steered to the left and right by operation of the steering motor, and is positioned in such a manner to have a scrub radius relative to the targeted wheel. The control device comprises: an acquisition part that is capable of acquiring propulsion motor actuation instruction information that instructs to actuate the propulsion motor and steering motor actuation instruction information that instructs to actuate the steering motor from an upper-level control section that is superior to the control device; and a motor information processing part that actuates the propulsion motor and concurrently actuates the steering motor in such a manner to: change an operation parameter of the steering motor and concurrently change an operation parameter of the propulsion motor based on the steering motor actuation instruction information acquired by the acquisition part; and change the operation parameter of the propulsion motor and concurrently change the operation parameter of the steering motor based on the propulsion motor actuation instruction information acquired by the acquisition part.

(8) A built-in driving and steering unit according to an embodiment of the present teaching is to be employed in an autonomous ground vehicle that is capable of running without a driver in/on the vehicle and includes a plurality of wheels. The built-in driving and steering unit comprises: a targeted wheel that is one of the plurality of wheels; a propulsion motor that rotates the targeted wheel around an axle of the targeted wheel; a steering motor that steers the targeted wheel to the left and right; a steering shaft that is connected to the steering motor, is configured such that the targeted wheel is steered to the left and right by operation of the steering motor, and is positioned in such a manner to have a scrub radius relative to the targeted wheel; and a control device. The built-in driving and steering unit is attachable to the autonomous ground vehicle. The control device includes: an acquisition part that is capable of acquiring propulsion motor actuation instruction information that instructs to actuate the propulsion motor and steering motor actuation instruction information that instructs to actuate the steering motor from an upper-level control section that is superior to the control device; and a motor information processing part that actuates the propulsion motor and concurrently actuates the steering motor in such a manner to: change an operation parameter of the steering motor and concurrently change an operation parameter of the propulsion motor based on the steering motor actuation instruction information acquired by the acquisition part; and change the operation parameter of the propulsion motor and concurrently change the operation parameter of the steering motor based on the propulsion motor actuation instruction information acquired by the acquisition part.

(9) A built-in driving and steering unit according to another embodiment of the present teaching is to be employed in an autonomous ground vehicle that is capable of running without a driver in/on the vehicle and includes a plurality of wheels. The built-in driving and steering unit comprises: a targeted wheel that is one of the plurality of wheels; a propulsion motor that rotates the targeted wheel around an axle of the targeted wheel; a steering motor that steers the targeted wheel to the left and right; and a steering shaft that is connected to the steering motor, is configured such that the targeted wheel is steered to the left and right by operation of the steering motor, and is positioned in such a manner to have a scrub radius relative to the targeted wheel. The built-in driving and steering unit is attachable to the autonomous ground vehicle. The built-in driving and steering unit is configured to actuate the propulsion motor and concurrently actuate the steering motor, based on both propulsion motor actuation instruction information that instructs to actuate the propulsion motor and steering motor actuation instruction information that instructs to actuate the steering motor, as follows.

Based on the steering motor actuation instruction information, an operation parameter of the steering motor changes and concurrently an operation parameter of the propulsion motor changes, and based on the propulsion motor actuation instruction information, the operation parameter of the propulsion motor changes and concurrently the operation parameter of the steering motor changes.

(10) An autonomous ground vehicle according to an embodiment of the present teaching comprises the driving and steering control system, the built-in driving and steering unit system or the built-in driving and steering unit of (1) to (9) above.

(11) The autonomous ground vehicle of (10) may further comprise the upper-level control section.

The “autonomous ground vehicle” only needs to have a mode in which the autonomous ground vehicle is capable of running without a driver staying in/on the vehicle or driving the vehicle. The autonomous ground vehicle may have other running modes. For example, the autonomous ground vehicle may have a mode in which the autonomous ground vehicle is capable of running with a driver staying in/on the vehicle and driving the vehicle. The autonomous ground vehicle may have a mode in which the autonomous ground vehicle is capable of running with a driver in/on the vehicle but without the driver driving the vehicle. The autonomous ground vehicle may have a mode in which the autonomous ground vehicle is capable of running without a driver in/on the vehicle but by being remotely operated. The remote operation may be conducted by wireless communication or by wire communication. The autonomous ground vehicle is an agricultural vehicle, for example.

The autonomous ground vehicle, for example, includes a battery. The battery, for example, feeds power to the driving and steering control system. The battery feeds power, for example, to the propulsion motor and the steering motor. The autonomous ground vehicle, for example, may include an electric generator that charges the battery. The electric generator does not output any mechanical power that moves the autonomous ground vehicle. The electric generator is, for example, an engine, a solar power system, or the like. The engine is a reciprocating engine, for example. The fuel for the engine is, for example, petrol, propane gas (LP gas), hydrogen, alcohol, biofuel, synthetic fuel, or the like. The engine may be, for example, a single-cylinder engine or a multi-cylinder engine. The multi-cylinder engine is, for example, a parallel multi-cylinder engine, a V-type multi-cylinder engine, a horizontally-opposed cylinder engine, or the like.

The autonomous ground vehicle, for example, includes a vehicle body and a plurality of wheels. The vehicle body forms the framework of the autonomous ground vehicle. The vehicle body may have a frame construction or a monocoque construction. The number of wheels only needs to be two or more and is not particularly limited. The autonomous ground vehicle may be, for example, a three-wheeled vehicle, a four-wheeled vehicle, a six-wheeled vehicle, or an eight-wheeled vehicle. The autonomous ground vehicle may have at least one wheel positioned in the center with respect to the left-right direction of the autonomous ground vehicle. The autonomous ground vehicle may have at least one wheel positioned on the left of the center with respect to the left-right direction of the autonomous ground vehicle. The autonomous ground vehicle may have at least one wheel positioned on the right of the center with respect to the left-right direction of the autonomous ground vehicle. The autonomous ground vehicle may have one or more left-right pairs of wheels. A left-right pair of wheels, for example, may be positioned such that the axle of the left wheel and the axle of the right wheel may be on the same axis or substantially on the same axis. A left-right pair of wheels, for example, need not be positioned such that the axle of the left wheel and the axle of the right wheel may be on the same axis or substantially on the same axis. In other words, a left-right pair of wheels may be positioned such that the axle of the left wheel and the axle of the right wheel are at different positions in the front-back direction. In sum, a left-right pair of wheels is, for example, composed of a wheel positioned on the left of the center with respect to the left-right direction of the autonomous ground vehicle and a wheel positioned on the right of the center with respect to the left-right direction of the autonomous ground vehicle. When the autonomous ground vehicle has a plurality of left wheels and a plurality of right wheels, a left-right pair of wheels is, for example, composed of a left wheel and a right wheel, the right wheel being the one least distant out of the right wheels from said left wheel in the front-back direction.

The “targeted wheel”, for example, includes a metal wheel and a rubber tire. The targeted wheel is positioned, for example, in the center with respect to the left-right direction of the autonomous ground vehicle. The targeted wheel may be one of a left-right pair of wheels. The targeted wheel may be one or both of the left and right wheels in a pair. One, some, or all of the plurality of wheels of the autonomous ground vehicle may be the targeted wheel(s). One targeted wheel, for example, is mechanically independent of the other wheels. One targeted wheel, for example, is steered independently of the other wheels. One targeted wheel, for example, rotates around its axle independently of the other wheels. One targeted wheel is independent of the other wheels, for example, in point of control. For example, the steering angle of one targeted wheel is controlled independently of the other wheels. For example, the rotation of one targeted wheel around its axle is controlled independently of the other wheels. The extension of the axle of the targeted wheel may intersect with the steering shaft. In other words, the axle of the targeted wheel may be positioned at the same position as the steering shaft with respect to the front-back direction. The extension of the axle of the targeted wheel need not intersect with the steering shaft. In other words, the axle of the targeted wheel may be located at a different position from the steering shaft with respect to the front-back direction.

The “propulsion motor” is an electric motor that converts electric energy to mechanical energy. The propulsion motor, for example, is located in the metal wheel of the targeted wheel and directly or indirectly connected to the hub. However, the propulsion motor may be located outside the targeted wheel. The propulsion motor may be mounted to the vehicle body. The propulsion motor is used to rotate the targeted wheel around the axle and does not steer the targeted wheel. Thus, the propulsion motor is an electric motor that moves the autonomous ground vehicle forward and backward.

The “steering motor” is an electric motor that converts electric energy to mechanical energy. The steering motor, for example, is located in the metal wheel of the targeted wheel. The steering motor, for example, is located at a smaller distance from the vehicle body than the propulsion motor is. The steering motor includes an output shaft, for example, extending toward the vehicle body. For example, the output shaft of the steering motor is connected to the steering shaft via a gear. However, the steering motor may be located outside the targeted wheel. The steering motor may be mounted to the vehicle body. The steering motor is used to rotate the targeted wheel around the steering shaft and does not rotate the targeted wheel around the axle. Thus, the steering motor is an electric motor that steers the targeted wheel to the left and right.

The “in-wheel motor” is located, for example, inside the wheel of the targeted wheel. The in-wheel motor may be entirely or partly located overlapping the metal wheel of the targeted wheel when the targeted wheel is viewed in the radial direction. The in-wheel motor need not be entirely located overlapping the metal wheel of the targeted wheel when the target wheel is viewed in the radial direction. However, the in-wheel motor is partly or entirely located overlapping the metal wheel of the targeted wheel when the targeted wheel is viewed in the axle direction.

The “steering shaft” is cylindrical, for example. The steering shaft has a steering axis around which the targeted wheel steers. The steering shaft extends, for example, in the up-down direction. The steering shaft is mounted to the vehicle body, for example, via a suspension arm. The steering shaft is, for example, fixed to the vehicle body in such a manner not to be rotatable on its axis. The steering shaft may be fixed to the vehicle body in such a manner to be rotatable on its axis. In this case, the steering shaft is fixed to the targeted wheel, and the steering shaft rotates together with the targeted wheel when the steering motor is rotated. The total maximum steering angle to the left and right in a targeted wheel is, for example, less than 360 degrees. The total maximum steering angle to the left and right in a targeted wheel is, for example, less than 180 degrees. The total maximum steering angle to the left and right in a targeted wheel is, for example, less than 90 degrees. The maximum steering angle of the targeted wheel may be limited mechanically or by control.

The “scrub radius” is a distance in the left-right direction (or the axle direction) between the intersection of the steering axis with the ground and the center of the targeted wheel. The center of the targeted wheel is the center of the ground contacting part of its tread in the axle direction. The scrub radius is not a distance in the front-back direction between the intersection of the steering axis with the ground and the center of the targeted wheel.

The “upper-level control section” only needs to be able to send the propulsion motor actuation instruction information and the steering motor actuation instruction information to the driving and steering control system. For example, let us assume that the autonomous ground vehicle includes: an autonomous navigation unit, a vehicle control device, and a driving and steering control device. The autonomous navigation unit determines what route the autonomous ground vehicle should run on, based on information sent from a camera mounted to the vehicle, the GPS (global positioning system), etc. The autonomous navigation unit sends information on a target vehicle speed and a target turn radius (or a target yaw rate) to the vehicle control device. The vehicle control device is a lower-level control device that is subordinate to the autonomous navigation unit. The vehicle control device composes propulsion motor actuation instruction information and steering motor actuation instruction information, based on the information on a target vehicle speed and a target turn radius received from the autonomous navigation unit. The vehicle control device sends the composed propulsion motor actuation instruction information and steering motor actuation instruction information to the driving and steering control device. The driving and steering control device is a lower-level control section that is subordinate to the vehicle control device and constitutes a driving and steering control system. In this case, the upper-level control section that is superior to the driving and steering control system is included in the vehicle control system. However, the upper-level control section is not necessarily included in the vehicle control device. For example, when the autonomous navigation unit is integrated with the vehicle control device, that is, when the autonomous navigation unit sends the propulsion motor actuation instruction information and the steering motor actuation instruction information to the driving and steering control system, the autonomous navigation unit includes the upper-level control section. Or when the vehicle control device is integrated with the driving and steering control device, that is, when the vehicle control device constitutes the driving and steering control system, the autonomous navigation unit includes the upper-level control section. The upper-level control section may be configured in a computer in which the “acquisition part” and the “motor information processing part” are configured or may be configured in another or some other computers that are capable of communicating with the computer.

The “driving and steering control system” means a system that involves rotation of the targeted wheel around the axle and steering of the targeted wheel. The driving and steering control system refers to, for example, electronic control software and hardware. For example, the driving and steering control system includes electronic control software that controls the propulsion motor and the steering motor, and a control device that carries out the electronic control. For example, the driving and steering control system includes a built-in driving and steering unit, and electronic control software that controls the propulsion motor and the steering motor. Thus, the driving and steering control system means a whole system that performs specified operations in response to an input of propulsion motor actuation instruction information and an input of steering motor actuation instruction information and actuates the propulsion motor and the steering motor in such a manner to reduce both speed interference and torque interference.

The “acquisition part” and the “motor information processing part” can be realized, for example, by a processor such as a CPU of a computer, a DSP (digital signal processor), or the like. The computer, for example, includes a non-volatile memory. The acquisition part and the motor information processing part, for example, read one or more programs including all or some of the operations carried out by the driving and steering control system from the non-volatile memory, and carry out the programs. These programs can be installed from outside. These programs, for example, are distributed in storage media form.

The acquisition part and the motor information processing part, for example, are configured in a computer of the control device constituting the driving and steering control system. The acquisition part and the motor information processing part, for example, may be configured in one computer or may be divided and separately configured in a plurality of computers that are capable of communicating with each other. For example, when the autonomous ground vehicle includes an autonomous navigation unit, a vehicle control device and a driving and steering control device, the acquisition part and the motor information processing part are configured in one control device or are divided and configured in a plurality of control devices separately. Table 1 shows specific examples of these cases.

TABLE 1

| Pat- | Autonomous | Vehicle Control | Driving and Steering |
|---|---|---|---|
| tern | Navigation Unit | Device | Control Device |
| 1 | | Upper-level control | Acquisition part |
| | | section | Motor information |
| | | | processing part |
| | | | (speed interference |
| | | | operation + |
| | | | torque interference |
| | | | operation) |
| 2 | Upper-level control | Acquisition part | Acquisition part |
| | section | Motor information | Motor information |
| | | processing part | processing part |
| | | (speed interference | (torque interference |
| | | operation) | operation) |
| 3 | Upper-level control | | Acquisition part |
| | section | | Motor information |
| | Acquisition part | | processing part |
| | Motor information | | (torque interference |
| | processing part | | operation) |
| | (speed interference | | |
| | operation) | | |
| 4 | Upper-level control | Acquisition part | |
| | section | Motor information | |
| | | processing part | |
| | | (speed interference | |
| | | operation + | |
| | | torque interference | |
| | | operation) | |
| 5 | Upper-level control | | Acquisition part |
| | section | | Motor information |
| | | | processing part |
| | | | (speed interference |
| | | | operation + |
| | | | torque interference |
| | | | operation) |
| 6 | Upper-level control | Acquisition part | |
| | section | Motor information | |
| | Acquisition part | processing part | |
| | Motor information | (torque interference | |
| | processing part | operation) | |
| | (speed interference | | |
| | operation) | | |
| 7 | Upper-level control | | |
| | section | | |
| | Acquisition part | | |
| | Motor information | | |
| | processing part | | |
| | (speed interference | | |
| | operation + | | |
| | torque interference | | |
| | operation) | | |

In Pattern 1, the acquisition part and the motor information processing part are configured in the driving and steering control device. The driving and steering control device carries out operations to reduce both speed interference and torque interference. The driving and steering control system includes the driving and steering control device but does not include the autonomous navigation unit or the vehicle control device. The upper-level control section is included in the vehicle control device.

In Pattern 2, the acquisition part and the motor information processing part are divided and configured in the vehicle control device and in the driving and steering control device separately. The vehicle control device carries out an operation to reduce speed interference, and the driving and steering control device carries out an operation to reduce torque interference. The driving and steering control system includes the vehicle control device and the driving and steering control device but does not include the autonomous navigation unit. The upper-level control section is included in the autonomous navigation unit.

In Pattern 3, the acquisition part and the motor information processing part are divided and configured in the autonomous navigation unit and in the driving and steering control device separately. The autonomous navigation unit carries out an operation to reduce speed interference, and the driving and steering control device carries out an operation to reduce torque interference. The driving and steering control system includes all of the autonomous navigation unit, the vehicle control device and the driving and steering control device. In this case, the upper-level control section corresponds to a functional part in the autonomous navigation unit that sends the propulsion motor actuation instruction information and the steering motor actuation instruction information to the motor information processing part that carries out an operation to reduce speed interference.

In Pattern 4, the acquisition part and the motor information processing part are configured in the vehicle control device. The vehicle control device carries out operations to reduce both speed interference and torque interference. The driving and steering control system includes the vehicle control device but does not include the autonomous navigation unit. The driving and steering control system may include the driving and steering control device and need not include the driving and steering control device. The upper-level control section is included in the autonomous navigation unit.

In Pattern 5, the acquisition part and the motor information processing part are configured in the driving and steering control device. The driving and steering control device carries out operations to reduce both speed interference and torque interference. The driving and steering control system includes the driving and steering control device but does not include the autonomous navigation unit or the vehicle control device. The upper-level control section is included in the autonomous navigation unit.

In Pattern 6, the acquisition part and the motor information processing part are divided and configured in the autonomous navigation unit and in the vehicle control device separately. The autonomous navigation unit carries out an operation to reduce speed interference, and the vehicle control device carries out an operation to reduce torque interference. The driving and steering control system includes the autonomous navigation unit and the vehicle control device. The driving and steering control system may include the driving and steering control device and need not include the driving and steering control device. In this case, the upper-level control section corresponds to a functional part in the autonomous navigation unit that sends the propulsion motor actuation instruction information and the steering motor actuation instruction information to the motor information processing part that carries out an operation to reduce speed interference.

In Pattern 7, the acquisition part and the motor information processing part are configured in the autonomous navigation unit. The autonomous navigation unit carries out operations to reduce both speed interference and torque interference. The driving and steering control system includes the autonomous navigation unit. The driving and steering control system may include the vehicle control device and the driving and steering control device and need not include the vehicle control device and the driving and steering control device. In this case, the upper-level control section corresponds to a functional part in the autonomous navigation unit that sends the propulsion motor actuation instruction information and the steering motor actuation instruction information to the motor information processing part that carries out operations to reduce both speed interference and torque interference.

Thus, the acquisition part and the motor information processing part only need to be configured in one or more control devices that can perform electronic control in the driving and steering control system, and the one or more control devices in which the acquisition part and the motor information processing part are configured are not particularly limited.

The motor information processing part, for example, corrects the steering motor actuation instruction information acquired by the acquisition part so as to change an operation parameter of the steering motor and concurrently change an operation parameter of the propulsion motor, and corrects the propulsion motor actuation instruction information acquired by the acquisition part so as to change the operation parameter of the propulsion motor and concurrently change the operation parameter of the steering motor. For example, based on the steering motor actuation instruction information, the motor information processing part corrects the target number of rotations of the propulsion motor instructed by the propulsion motor actuation instruction information and calculates a proper number of rotations of the propulsion motor. For example, the motor information processing part calculates an output torque of the propulsion motor based on the corrected instruction information on actuation of the propulsion motor (corrected propulsion motor actuation instruction information). For example, based on the calculated output torque of the propulsion motor, the motor information processing part corrects the instruction information on actuation of the steering motor indicated by the steering motor actuation instruction information. For example, the motor information processing part calculates a target output torque of the steering motor based on the corrected instruction information on actuation of the steering motor (corrected steering motor actuation instruction information).

When the motor information processing part receives the propulsion motor actuation instruction information and the steering motor actuation instruction information, for example, the motor information processing part corrects the propulsion motor actuation instruction information and thereafter corrects the steering motor actuation instruction information. When the motor information processing part receives the propulsion motor actuation instruction information and the steering motor actuation instruction information, however, the motor information processing part may correct the steering motor actuation instruction information and thereafter correct the propulsion motor actuation instruction information, for example.

When the targeted wheel is one of a left-right pair of wheels, the motor information processing part may actuate the propulsion motor and the steering motor in view of the Ackermann steering geometry. In other words, the motor information processing part may actuate the propulsion motor and the steering motor such that the steering angle of the targeted wheel will be different from the steering angle of the other wheel in the pair. When the autonomous ground vehicle includes the targeted wheel and another wheel that is at a different position from the targeted wheel with respect to the front-back direction, the motor information processing part may actuate the propulsion motor and the steering motor such that the rotation speed of the targeted wheel will be different from the rotation speed of the other wheel.

The locations of the upper-level control section, the acquisition part and the motor information processing part are not particularly limited. Table 2 below shows specific examples of the locations of the upper-level control section, the acquisition part, and the motor information processing part.

As in Pattern A, the upper-level control section, the acquisition part, and the motor information processing part may be located in the vehicle body of the autonomous ground vehicle. More specifically, the upper-level control section, the acquisition part and the motor information processing part may be configured in a control device located in the vehicle body of the autonomous ground vehicle.

As in Pattern B, the upper-level control section may be located in the vehicle body of the autonomous ground vehicle, and the acquisition part and the motor information processing part may be divided and separately located in the vehicle body and the targeted wheel. More specifically, the upper-level control section may be configured in a control device located in the vehicle body of the autonomous ground vehicle, and the acquisition part and the motor information processing part may be configured in a control device located in the vehicle body and in a control device located in the targeted wheel (or the built-in driving and steering unit).

As in Pattern C, the upper-level control section may be located in the vehicle body of the autonomous ground vehicle, and the acquisition part and the motor information processing part may be located in the targeted wheel (or the built-in driving and steering unit). More specifically, the upper-level control section may be configured in a control device located in the vehicle body of the autonomous ground vehicle, and the acquisition part and the motor information processing part may be configured in a control device located in the targeted wheel (or the built-in driving and steering unit).

TABLE 2

| | | Targeted Wheel or Built-in |
|---|---|---|
| Pattern | Vehicle Body | Driving and Steering Unit |
| A | Upper-level control section | |
| | Acquisition part | |
| | Motor information processing | |
| | part | |
| | (speed interference | |
| | operation + torque | |
| | interference operation) | |
| B | Upper-level control section | Acquisition part |
| | Acquisition part | Motor information processing |
| | Motor information processing | part |
| | part | (torque interference operation) |
| | (speed interference operation) | |
| C | Upper-level control section | Acquisition part |
| | | Motor information processing |
| | | part |
| | | (speed interference |
| | | operation + torque |
| | | interference operation) |

The “propulsion motor actuation instruction information” includes, for example, information that indicates a target rotation speed of the targeted wheel around the axle or a target peripheral speed of the targeted wheel. For example, when the upper-level control section determines to move the autonomous ground vehicle neither forward nor backward (to stop the autonomous ground vehicle), the propulsion motor actuation instruction information includes information that instructs to set the rotation speed of the targeted wheel around the axle to zero. For example, when the upper-level control section determines to move the autonomous ground vehicle forward or backward, the propulsion motor actuation instruction information includes information that instructs to set the rotation speed of the targeted wheel around the axle to a specified value. The propulsion motor actuation instruction information is one to be inputted to the driving and steering control system. The propulsion motor actuation instruction information is one that instructs to actuate the propulsion motor not taking into account the scrub radius. The propulsion motor actuation instruction information does not include information on the scrub radius. The propulsion motor actuation instruction information does not include any value calculated based on the scrub radius. The propulsion motor actuation instruction information does not include information that instructs to actuate the steering motor.

The “steering motor actuation instruction” includes, for example, information that indicates a target steering angle of the targeted wheel. For example, when the upper-level control section determines to steer the targeted wheel to the left or right, the steering motor actuation instruction information includes information that instructs to set the steering angle of the targeted wheel to a specified value. For example, when the upper-level control section determines to steer the targeted wheel to the left or right, the steering motor actuation instruction information includes information that instructs to set the steering angle of the targeted wheel to a specified value. The steering motor actuation instruction information is one to be inputted to the driving and steering control system. The steering motor actuation instruction information is, for example, one that instructs to actuate the steering motor not taking into account the scrub radius. The steering motor actuation instruction information, for example, does not include information on the scrub radius. The steering motor actuation instruction information, for example, does not include any value calculated based on the scrub radius. The steering motor actuation instruction information, for example, does not include information that instructs to actuate the propulsion motor.

The “operation parameter” is the value of an electric current to be applied to the propulsion motor or the steering motor. However, the operation parameter only needs to be a parameter used to control the operating conditions of the propulsion motor and the steering motor and is not particularly limited. For example, the output torque, rotation speed, etc. are usable as such a parameter.

The “built-in driving and steering unit system” means a hardware set of the built-in driving and steering unit and a control device in which electric control to be performed by the driving and steering control system is configured. The control device may be integrated with the built-in driving and steering unit or it may be a separate body.

The “built-in driving and steering unit” is, for example, composed of the targeted wheel, the propulsion motor, the steering motor, and the steering shaft. These components of the built-in driving and steering unit, for example, are attachable as one body to the autonomous ground vehicle. The built-in driving and steering unit may include the control device constituting the driving and steering control system and need not include.

Some embodiments of the present teaching will hereinafter be described in detail with reference to the drawings, and the detailed description of the embodiments will provide a clearer picture of the above-mentioned objective and other objectives, the features, the aspects and the advantages of the present teaching. The term “and/or” used herein includes one of the associated items in a list and all possible combinations of the associated items. The terms “including”, “comprising”, or “having”, and variations thereof used herein specify the presence of stated features, steps, operations, elements, components, and/or equivalents thereof, and can include one or more steps, operations, elements, components, and/or one or more of their groups. Unless otherwise defined, all terms (including technical and scientific terms) used herein have the same meanings as commonly understood by one of ordinary skill in the art to which the present teaching pertains. It should be understood that terms, such as those defined in commonly used dictionaries, should be interpreted as having meanings that are consistent with their meanings in the context of the present disclosure and relevant art and should not be interpreted in an idealized or overly formal sense unless expressly so defined herein. It should be understood that the description of the present teaching discloses a number of techniques and steps. Each of these has an individual benefit, and each can also be used in conjunction with one or more, or in some cases all, of the other disclosed techniques. Accordingly, for the sake of clarity, this description will refrain from repeating every possible combination of the individual steps in an unnecessary fashion. Nevertheless, Description and Claims should be read with the understanding that such combinations are entirely within the scope of the present teaching and the claims. In the description given below, for the purpose of explanation, numerous specific details are set forth in order to provide a complete understanding of the present teaching. It will be apparent, however, that those skilled in the art may practice the present teaching without these specific details. The present disclosure is to be considered as exemplification of the present teaching and is not intended to limit the present teaching to the specific embodiments illustrated by drawings or descriptions below.

### Effect of Invention

The present teaching makes it possible to reduce both speed interference and torque interference between a steering motor and a propulsion motor in an autonomous ground vehicle with a scrub radius of the wheels.

### BRIEF DESCRIPTION OF DRAWINGS

FIG. 1A is a schematic front view that shows a part of an autonomous ground vehicle according to an embodiment of the present teaching, and FIG. 1B is a schematic functional block diagram of a driving and steering control system according to the embodiment of the present teaching.

FIG. 2A is a detailed front view that shows the part of the autonomous ground vehicle according to the embodiment of the present teaching, FIG. 2B is a functional block diagram of an autonomous navigation unit, a vehicle control device, and a driving and steering control device, and FIG. 2C is a functional block diagram of the driving and steering control device in the driving and steering control system.

FIG. 3A is a schematic view that shows steering of a targeted wheel and rotation of the targeted wheel around an axle, and FIG. 3B is a schematic plan view that shows a state in which the autonomous ground vehicle is accelerating forward.

FIG. 4 is a schematic front view that shows a part of an autonomous ground vehicle according to a modification of the embodiment.

FIGS. 5A and 5B are functional block diagrams of an autonomous navigation unit, a vehicle control device, and a driving and steering control device according to another modification of the embodiment.

### DESCRIPTION OF EMBODIMENTS

A driving and steering control system, a built-in driving and steering unit system, a built-in driving and steering unit, and an autonomous ground vehicle according to an embodiment of the present teaching will hereinafter be described with reference to the drawings. The embodiment described below is merely an example. The present teaching shall not be considered limited to the embodiment below.

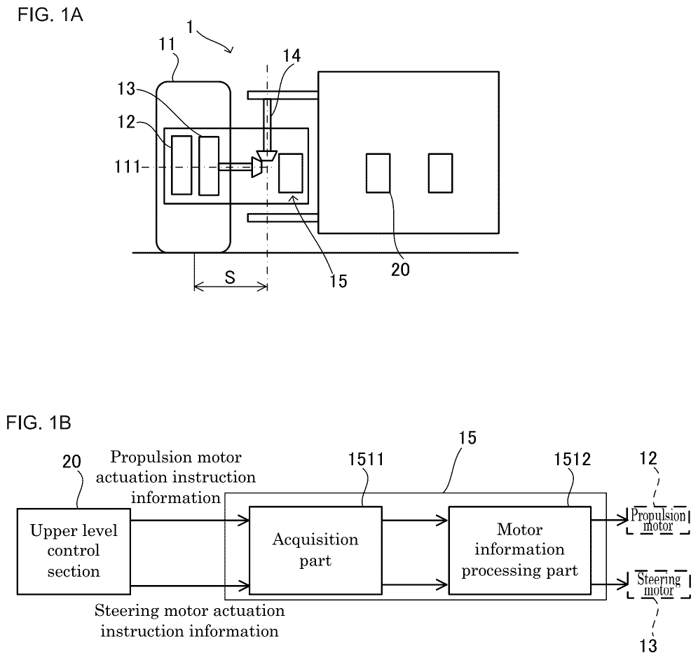

FIG. 1A is a schematic front view that shows a part of the autonomous ground vehicle according to the embodiment of the present teaching. This embodiment illustrates a case in which the autonomous ground vehicle 1 does not include any driver's seat. Accordingly, the autonomous ground vehicle 1 is capable of running without a driver staying in the vehicle or driving (including remotely operating) the vehicle. The autonomous ground vehicle 1 includes a targeted wheel 11, a propulsion motor 12, a steering motor 13, a steering shaft 14, and a driving and steering control system 15.

The autonomous ground vehicle 1 includes a left-right pair of front wheels and a left-right pair of rear wheels, i.e., four wheels although not shown in the drawings. The targeted wheel 11 is a right front wheel, which is one of the left-right pair of front wheels.

The propulsion motor 12 is an in-wheel motor that is located inside the targeted wheel 11. An output shaft of the propulsion motor 12 is connected to an axle 111 of the targeted wheel 11. The propulsion motor 12 rotates the targeted wheel 11 around the axle 111 of the targeted wheel.

The steering motor 13 is an in-wheel motor that is located inside the targeted wheel 11. An output shaft of the steering motor 13 extends in a left-right direction. The output shaft of the steering motor 13 is connected to the steering shaft 14 via a bevel gear. The steering motor 13 steers the targeted wheel 11 to the left and right.

The steering shaft 14 extends in an up-down direction and is connected to the output shaft of the steering motor 13. The steering shaft 14 is located between the targeted wheel 11 and the vehicle body of the autonomous ground vehicle 1 with respect to the left-right direction. The steering shaft 14 is configured such that the targeted wheel 11 is steered to the left and right by operation of the steering motor 13. For example, the steering shaft 14 is fixed so as not to be rotatable relative to the vehicle body of the autonomous ground vehicle 1. When the steering motor 13 operates, the steering motor 13 and the targeted wheel 11 turn around the steering shaft 14. The steering shaft 14 is positioned in such a manner to have a scrub radius S relative to the targeted wheel 11.

FIG. 1B is a schematic functional block diagram of the driving and steering control system according to the present embodiment. The driving and steering control system 15 includes an acquisition part 1511 and a motor information processing part 1512.

The acquisition part 1511 is capable of acquiring propulsion motor actuation instruction information that instructs to actuate the propulsion motor 12 and steering motor actuation instruction information that instructs to actuate the steering motor 13 from an upper-level control section 20 that is superior to the driving and steering control system 15.

The motor information processing part 1512 actuates the propulsion motor 12 and concurrently actuates the steering motor 13 in such a manner to change an operation parameter of the steering motor 13 and concurrently change an operation parameter of the propulsion motor 12 based on the steering motor actuation instruction information acquired by the acquisition part 1511 and to change the operation parameter of the propulsion motor 12 and concurrently change the operation parameter of the steering motor 13 based on the propulsion motor actuation instruction information acquired by the acquisition part 1511.

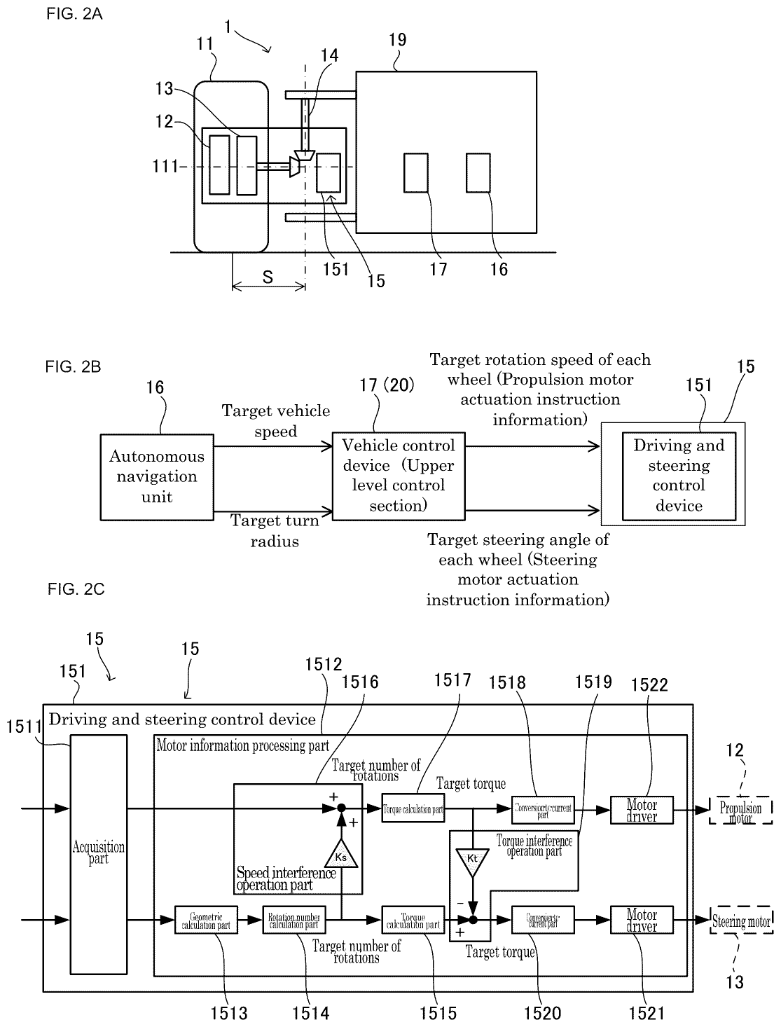

The driving and steering control system 15 according to the embodiment will hereinafter be described in more detail. FIG. 2A is a detailed front view that shows the part of the autonomous ground vehicle of the present teaching. The autonomous ground vehicle 1 further includes an autonomous navigation unit 16 and a vehicle control device 17. The autonomous navigation unit 16 and the vehicle control device 17 are attached to a vehicle body 19 of the autonomous ground vehicle 1. The driving and steering control system 15 includes a driving and steering control device 151.

FIG. 2B is a functional block diagram of the autonomous navigation unit 16, the vehicle control device 17, and the driving and steering control device 151. The autonomous navigation unit 16 determines what route the autonomous ground vehicle 1 should run on. For example, the autonomous navigation unit 16 determines what route the autonomous ground vehicle 1 should run on, based on information from a camera mounted on the vehicle body, GPS, etc. Once the autonomous navigation unit 16 determines the route, the autonomous navigation unit 16 sends a target vehicle speed and a target turn radius to the vehicle control device 17.

The vehicle control device 17 determines a target rotation speed of the propulsion motor 12 based on the target vehicle speed received from the autonomous navigation unit 16. The vehicle control device 17 determines a target steering angle of the steering motor 13 based on the target turn radius received from the autonomous navigation unit 16. The vehicle control device 17 sends the determined target rotation speed and target turn radius to the driving and steering control device 151. This target rotation speed corresponds to the propulsion motor actuation instruction information that instructs to actuate the propulsion motor 12. The target turn radius corresponds to the steering motor actuation instruction information that instructs to actuate the steering motor 13. Thus, in this embodiment, the vehicle control device 17 corresponds to the upper-level control section that is superior to the driving and steering control system 15. The propulsion motor actuation instruction information and the steering motor actuation instruction information are configured without inclusion of information on the scrub radius S and free of any basis on the scrub radius S.

FIG. 2C is a functional block diagram of the driving and steering control device 151 in the driving and steering control system 15. The driving and steering control device 151 includes the acquisition part 1511 and the motor information processing part 1512.

The acquisition part 1511 is capable of acquiring propulsion motor actuation instruction information that instructs to actuate the propulsion motor 12 and steering motor actuation instruction information that instructs to actuate the steering motor 13 from the upper-level control section (vehicle control device 17) that is superior to the driving and steering control system 15. When the acquisition part 1511 acquires propulsion motor actuation instruction information and steering motor actuation instruction information, the acquisition part 1511 sends these pieces of information to the motor information processing part 1512.

The motor information processing part 1512 actuates the propulsion motor 12 and concurrently actuates the steering motor 13 in such a manner to change an operation parameter of the steering motor 13 and concurrently change an operation parameter of the propulsion motor 12 based on the steering motor actuation instruction information acquired by the acquisition part 1511 and to change the operation parameter of the propulsion motor 12 and concurrently change the operation parameter of the steering motor 13 based on the propulsion motor actuation instruction information acquired by the acquisition part 1511.

More specifically, the motor information processing part 1512 includes a geometric calculation part 1513, a rotation number calculation part 1514, torque calculation parts 1515 and 1517, a speed interference operation part 1516, conversion-to-current parts 1518 and 1520, a torque interference operation part 1519, and motor drivers 1521 and 1522.

First, based on the steering motor actuation instruction information received from the acquisition part 1511, which does not take into account the scrub radius S, the geometric calculation part 1513 geometrically calculates a collected target steering angle taking into account the scrub radius S. The geometric calculation part 1513 sends the calculated collected target steering angle to the rotation number calculation part 1514.

Next, on receiving the collected target steering angle from the geometric calculation part 1513, the rotation number calculation part 1514 calculates a target number of rotations of the steering motor 13 that is needed to steer the targeted wheel from the current steering angle of the targeted wheel to the collected target steering angle. The rotation number calculation part 1514 sends the calculated target number of rotations of the steering motor 13 to the torque calculation part 1515 and the speed interference operation part 1516.

Next, the torque calculation part 1515 calculates a provisional output torque of the steering motor 13 from the target number of rotations of the steering motor 13 received from the rotation number calculation part 1514. The torque calculation part 1515 sends the calculated provisional output torque of the steering motor 13 to the torque interference operation part 1519.

Next, the speed interference operation part 1516 calculates a value of multiplying the target number of rotations of the steering motor 13 received from the rotation number calculation part 1514 with a predetermined coefficient Ks and sends the calculated product to the torque calculation part 1517.

Next, based on the propulsion motor actuation instruction information received from the acquisition part 1511 and the value of multiplying the target number of rotations of the steering motor 13 with the predetermined coefficient Ks received from the speed interference operation part 1516, the torque calculation part 1517 collects the rotation speed of the targeted wheel 11 indicated by the propulsion motor actuation instruction information and determines an output torque (a target torque) of the propulsion motor 12. The torque calculation part 1517 sends the determined target torque of the propulsion motor 12 to the conversion-to-current part 1518 and the torque interference operation part 1519.

Next, the torque interference operation part 1519 calculates a value of multiplying the target torque of the propulsion motor 12 received from the torque calculation part 1517 with a predetermined coefficient Kt. The torque interference operation part 1519 calculates an output torque (a target torque) of the steering motor 13 by subtracting the calculated a value of multiplying the target torque of the propulsion motor 12 with the predetermined coefficient Kt from the provisional output torque of the steering motor 13 received from the torque calculation part 1515. The torque interference operation part 1519 sends the calculated target torque of the steering motor 13 to the conversion-to-current part 1520.

Next, the conversion-to-current part 1520 converts the target torque of the steering motor 13 received from the torque interference operation part 1519 to a target current value and sends this target current value to the motor driver 1521. Also, the conversion-to-current part 1518 converts the target torque of the propulsion motor 12 received from the torque calculation part 1517 to a target current value and sends this target current value to the motor driver 1522.

Next, the motor driver 1522 applies an electric current of the target current value received from the conversion-to-current part 1518 to the propulsion motor 12. Also, the motor driver 1521 applies an electric current of the target current value received from the conversion-to-current part 1520 to the steering motor 13.

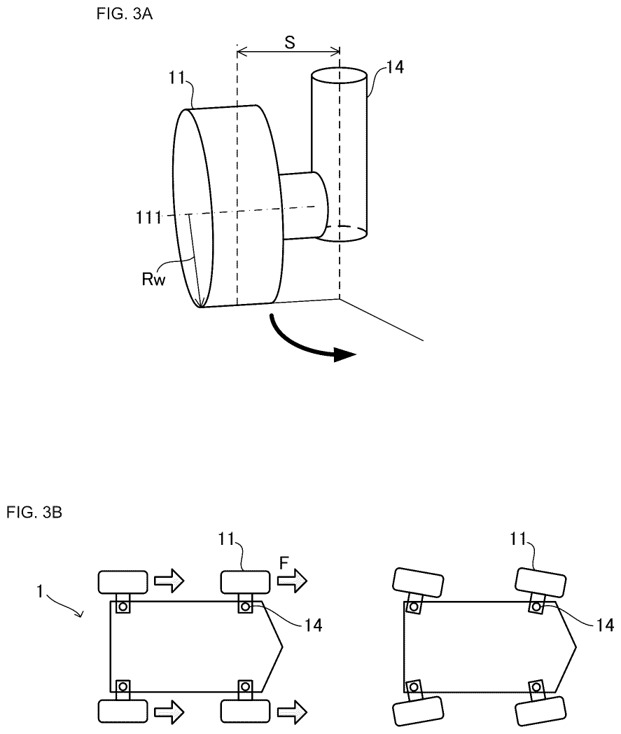

FIG. 3A is a schematic diagram that shows steering of the targeted wheel 11 and rotation of the targeted wheel 11 around the axle 111. When the targeted wheel 11 of the vehicle with the scrub radius S is steered while the vehicle is at a stop, the targeted wheel 11 is turned around the steering shaft 14 by the steering motor 13 and thereby steered. At the time, the propulsion motor 12 is at a stop, and therefore the targeted wheel 11 does not rotate around the axle 111. Accordingly, the targeted wheel 11 is steered while scraping against the ground. However, the driving and steering control system 15 according to the embodiment actuates not only the steering motor 13 but also the propulsion motor 12 in response to acquisition of the steering motor actuation instruction information that instructs to actuate the steering motor 13. This enables the targeted wheel 11 to rotate around the axle 111 when the targeted wheel 11 is steered. Therefore, speed interference, which is interference from the propulsion motor 12 in steering of the targeted wheel 11 as described above, can be reduced.

FIG. 3B is a schematic plan view that shows a state in which the autonomous ground vehicle 1 is accelerating forward. When the vehicle with the scrub radius S accelerates straight forward without steering the targeted vehicle 11, the targeted wheel 11 receives a reaction force F in the forward direction from the ground. By the reaction force F, the targeted wheel 11 turns around the steering shaft 14, that is, is steered. At the time, since the steering motor 13 is not active, the steering angle of the targeted wheel 11 deviates from a target value. However, the driving and steering control system 15 according to the embodiment actuates not only the propulsion motor 12 but also the steering motor 13 in response to acquisition of the propulsion motor actuation instruction information that instructs to actuate the propulsion motor 12. This enables the targeted wheel 11 to be steered when the targeted wheel 11 rotates around the axle, that is, when the targeted wheel 11 receives a moment around the steering shaft 14 by the driving torque. Therefore, torque interference, which causes a deviation of the steering angle of the targeted wheel 11 from a target value, can be reduced. Thus, with the driving and steering control system 15 according to the embodiment, the autonomous ground vehicle 1 with the scrub radius S is capable of reducing both speed interference and torque interference between the propulsion motor 12 and the steering motor 13.

With reference to FIG. 3A, the coefficient Ks used to reduce speed interference is described. The speed of the tread of the targeted wheel 11 by the propulsion motor 12 is expressed by a value of multiplying a rotation speed W1 (rad/s) of the targeted wheel 11 around the axle 111 with a radius Rw (m) of the targeted wheel 11. On the other hand, the speed of the tread of the targeted wheel 11 by the steering motor 13 is expressed by a value of multiplying a steering turning speed W2 (rad/s) of the targeted wheel 11 around the steering shaft 14 with a scrub radius S (m). When speed interference does not occur, the targeted wheel 11 is steered without scraping against the ground. In this case, the following formula (1) holds.

$$W 1 \cdot Rw = W 2 \cdot S \qquad ( 1 )$$

The relation between the motor revolutions Wa (rad/s) of the propulsion motor 12 and the rotation speed W1 and the relation between the motor revolutions Wb (rad/s) of the steering motor 13 and the steering turning speed W2 are expressed by the following formulae (2) and (3), taking into account the gear ratio Za of the propulsion motor 12 and the gear ratio Zb of the steering motor 13.

$$W 1 = Wa / Za \qquad ( 2 )$$

$$W 2 = W b / Zb \qquad ( 3 )$$

From the formulae (1) to (3), the following formula (4) is derived, and the coefficient Ks is calculated as expressed by the following formula (5).

$$Wa = \{ ( S / Rw ) \cdot ( Za / Zb ) \} \cdot W b \qquad ( 4 )$$

$$Ks = \{ ( S / Rw ) \cdot ( Za / Zb ) \} \qquad ( 5 )$$

Next, the coefficient Kt used to reduce torque interference is described. A steering moment Ms (N·m) to be additionally applied to the targeted wheel 11 to reduce torque interference is expressed by the following formula (6), using the reaction force F (N) that the targeted wheel 11 receives from the ground and the scrub radius S.

$$Ms = - F \cdot S \qquad ( 6 )$$

The steering moment Ms is expressed by the following formula (7), using the output torque Tb and gear ratio Zb of the steering motor 13. The torque that the targeted wheel 11 receives due to the reaction force F is expressed by the following formula (8), using the output torque Ta and gear ratio Za of the propulsion motor 12.

$$Ms = Tb \cdot Zb \qquad ( 7 )$$

$$F \cdot Rw = Ta \cdot Za \qquad ( 8 )$$

From the formulae (6) to (8), the following formula (9) is derived, and the coefficient Kt is calculated as expressed by the following formula (10).

$$Tb = - \{ ( S / Rw ) \cdot ( Za / Zb ) \} \cdot Ta \qquad ( 9 )$$

$$Kt = \{ ( S / Rw ) \cdot ( Za / Zb ) \} \qquad ( 10 )$$

### Other Embodiments

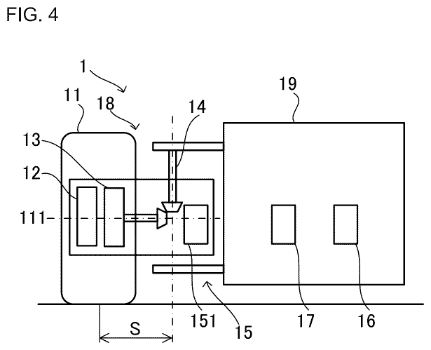

In the above-described embodiment, the driving and steering control system 15 may include a built-in driving and steering unit 18 as shown in FIG. 4. The built-in driving and steering unit 18 includes the targeted wheel 11, the propulsion motor 12, the steering motor 13, and the steering shaft 14. The built-in driving and steering unit 18 is attachable to and detachable from the vehicle body 19 of the autonomous ground vehicle 1. The built-in driving and steering unit 18 may include the driving and steering control device 151 and need not include the driving and steering control device 151. For example, the driving and steering control device 151 may be positioned in the vehicle body 19.

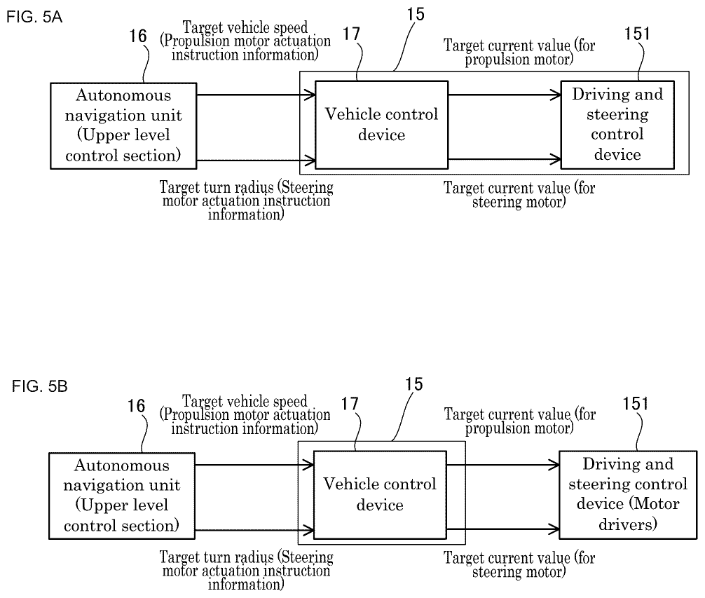

As shown in FIG. 5A, the driving and steering control system 15 may include the vehicle control device 17 and the driving and steering control device 151. In this case, the autonomous navigation unit 16 includes the upper-level control section 20 and sends the propulsion motor actuation instruction information and the steering motor actuation instruction information to the driving and steering control system 15.

As shown in FIG. 5B, the driving and steering control system 15 may be constituted by the vehicle control device 17. In this case, the autonomous navigation unit 16 includes the upper-level control section 20 and sends the propulsion motor actuation instruction information and the steering motor actuation instruction information to the driving and steering control system 15.

Additionally, in the above-described embodiment, each of the vehicle control device 17 and the driving and steering control device 151 may be located in the vehicle body 19 of the autonomous ground vehicle 1, the targeted wheel 11 or the built-in driving and steering unit 18.

The embodiments and modifications described above and/or illustrated by the drawings are to make the present disclosure easier to understand and not to limit the concept of the present disclosure. It is possible to adapt or alter the embodiments and modifications described above without departing from the gist thereof. The gist includes all equivalent elements, modifications, omissions, combinations (for example, combinations of features of the embodiments and modifications), adaptations and alterations as would be appreciated by those in the art based on the embodiments and modifications disclosed herein. The limitations in the claims are to be interpreted broadly based on the language employed in the claims and not limited to the embodiments and modifications described in the present specification or during the prosecution of the present application. Such embodiments and modifications are to be understood as non-exclusive. For example, the terms “preferable” and “good” in the present specification are to be understood as non-exclusive, and these terms mean “preferable but not limited to this” and “good but not limited to this”, respectively.

### LIST OF REFERENCE SIGNS

1: autonomous ground vehicle
11: targeted wheel
111: axle
12: propulsion motor
13: steering motor
14: steering shaft
15: driving and steering control system
151: driving and steering control device
1511: acquisition part
1512: motor information processing part
16: autonomous navigation unit
17: vehicle control device
18: built-in driving and steering unit
19: vehicle body
F: reaction force
S: scrub radius
Rw: radius of targeted wheel

1. A driving and steering control system to be employed in an autonomous ground vehicle that is capable of running without a driver in/on the vehicle, the autonomous ground vehicle including:
a plurality of wheels including a targeted wheel,
a propulsion motor that rotates the targeted wheel around an axle of the targeted wheel,
a steering motor that steers the targeted wheel to left and right of the autonomous ground vehicle,
a steering shaft that:
is connected to the steering motor,
is configured to steer the targeted wheel by operation of the steering motor, and
is positioned in such a manner to have a scrub radius relative to the targeted wheel, and
an upper-level control section that is configured to output:
propulsion motor actuation instruction information for actuating the propulsion motor, and
steering motor actuation instruction information for actuating the steering motor,
the driving and steering control system comprising:
an acquisition device that is configured to acquire the propulsion motor actuation instruction information and the steering motor actuation instruction information from the upper-level control section; and
a motor information processing device that is configured to concurrently actuate the propulsion motor and the steering motor in such a manner to:
concurrently change an operation parameter of the steering motor and an operation parameter of the propulsion motor based on the steering motor actuation instruction information acquired by the acquisition device, and
concurrently change the operation parameter of the propulsion motor and the operation parameter of the steering motor based on the propulsion motor actuation instruction information acquired by the acquisition device.

2. The driving and steering control system according to claim 1, wherein
the motor information processing device is further configured to, while actuating both the steering motor and the propulsion motor, in response to receipt by the acquisition device a new piece of information that provides a change in only one, but not both, of the steering motor actuation instruction information and the propulsion motor actuation instruction information, concurrently change the operation parameters of both the steering motor and the propulsion motor.

3. The driving and steering control system according to claim 1, wherein
the motor information processing device is further configured to, when the acquisition device receives the steering motor actuation instruction information and the propulsion motor actuation instruction information, concurrently actuate the propulsion motor and the steering motor, such that the propulsion motor is inhibited from interfering with the steering motor in steering of the targeted wheel, and such that a change in the steering angle caused by the propulsion motor is inhibited by the steering motor.

4. The driving and steering control system according to claim 1, wherein
the targeted wheel, the propulsion motor, the steering motor, and the steering shaft constitute a built-in driving and steering unit that is attachable to the autonomous ground vehicle.

5. The driving and steering control system according to claim 1, wherein
the steering motor actuation instruction information and the propulsion motor actuation instruction information are configured without information on the scrub radius and free of any information on the scrub radius.

6. The driving and steering control system according to claim 1, wherein
both the propulsion motor and the steering motor are in-wheel motors mounted to the targeted wheel.

7. A built-in driving and steering unit system to be employed in an autonomous ground vehicle that is capable of running without a driver in/on the vehicle, the autonomous ground vehicle including an upper-level control section, the built-in driving and steering unit system comprising:
a built-in driving and steering unit that is attachable to the autonomous ground vehicle, the built-in driving and steering unit including:
a targeted wheel;
a propulsion motor that rotates the targeted wheel around an axle of the targeted wheel;
a steering motor that steers the targeted wheel to left and right of the autonomous ground vehicle; and
a steering shaft that:
is connected to the steering motor,
is configured to steer the targeted wheel by operation of the steering motor, and
is positioned in such a manner to have a scrub radius relative to the targeted wheel; and
a control device, including:
an acquisition device that is configured to receive
propulsion motor actuation instruction information for actuating the propulsion motor, and
steering motor actuation instruction information for actuating the steering motor,
from the upper-level control section, and
a motor information processing device configured to concurrently actuate the propulsion motor and the steering motor in such a manner to:
concurrently change an operation parameter of the steering motor and an operation parameter of the propulsion motor based on the steering motor actuation instruction information acquired by the acquisition device; and
concurrently change the operation parameter of the propulsion motor and the operation parameter of the steering motor based on the propulsion motor actuation instruction information acquired by the acquisition device.

8. A built-in driving and steering unit attachable to an autonomous ground vehicle that is capable of running without a driver in/on the vehicle, the autonomous ground vehicle including an upper-level control section, the built-in driving and steering unit comprising:
a targeted wheel;
a propulsion motor that rotates the targeted wheel around an axle of the targeted wheel;
a steering motor that steers the targeted wheel to left and right of the autonomous ground vehicle;
a steering shaft that:
is connected to the steering motor,
is configured to steer the targeted wheel by operation of the steering motor, and
is positioned in such a manner to have a scrub radius relative to the targeted wheel; and
a control device, including:
an acquisition device that is configured to acquire
propulsion motor actuation instruction information for actuating the propulsion motor, and
steering motor actuation instruction information for actuating the steering motor,
from the upper-level control section; and
a motor information processing device configured to concurrently actuate the propulsion motor and the steering motor in such a manner to:
concurrently change an operation parameter of the steering motor and an operation parameter of the propulsion motor based on the steering motor actuation instruction information acquired by the acquisition device; and
concurrently change the operation parameter of the propulsion motor and the operation parameter of the steering motor based on the propulsion motor actuation instruction information acquired by the acquisition device.

9. A built-in driving and steering unit attachable to an autonomous ground vehicle that is capable of running without a driver in/on the vehicle, the autonomous ground vehicle including an upper-level control section, the built-in driving and steering unit comprising:
a targeted wheel;
a propulsion motor that rotates the targeted wheel around an axle of the targeted wheel;
a steering motor that steers the targeted wheel to left and right of the autonomous ground vehicle; and
a steering shaft that:
is connected to the steering motor,
is configured to steer the targeted wheel by operation of the steering motor, and
is positioned in such a manner to have a scrub radius relative to the targeted wheel, wherein
the built-in driving and steering unit is configured to concurrently actuate the propulsion motor and the steering motor, based on both propulsion motor actuation instruction information for actuating the propulsion motor and steering motor actuation instruction information for actuating the steering motor, such that:
based on the steering motor actuation instruction information, an operation parameter of the steering motor and an operation parameter of the propulsion motor change concurrently; and
based on the propulsion motor actuation instruction information, the operation parameter of the propulsion motor and the operation parameter of the steering motor change concurrently.

10. An autonomous ground vehicle comprising the driving and steering control system according to claim 1.

11. The autonomous ground vehicle according to claim 10, further comprising the upper-level control section.

12. An autonomous ground vehicle comprising the built-in driving and steering unit system according to claim 7.

13. The autonomous ground vehicle according to claim 12, further comprising the upper-level control section.

14. An autonomous ground vehicle comprising the built-in driving and steering unit according to claim 8.

15. The autonomous ground vehicle according to claim 14, further comprising the upper-level control section.

16. An autonomous ground vehicle comprising the built-in driving and steering unit according to claim 9.

17. The autonomous ground vehicle according to claim 16, further comprising the upper-level control section.
